(19) United States
(12) Patent Application Publication
(10) Pub. No.: US 2013/0336690 A1
(43) Pub. Date: Dec. 19, 2013

(54) APPARATUS, METHOD AND SYSTEM FOR CONTROLLING NIP GEOMETRY IN A PRINTING SYSTEM

(71) Applicants: Matthew Ryan MCLAUGHLIN, Rochester, NY (US); Donald Richard FESS, Rochester, NY (US); Brian J. PERRY, Bloomfield, NY (US)

(72) Inventors: Matthew Ryan MCLAUGHLIN, Rochester, NY (US); Donald Richard FESS, Rochester, NY (US); Brian J. PERRY, Bloomfield, NY (US)

(73) Assignee: XEROX CORPORTATION, Norwalk, CT (US)

(21) Appl. No.: 13/495,039

(22) Filed: Jun. 13, 2012

(51) Int. Cl. G03G 15/20

(52) U.S. Cl. 399/329

(57) ABSTRACT

An apparatus, system and method are provided for fusing an image to a substrate at a fusing nip defined by a first pressure member and a pressure belt in a belt-roll fuser. The belt-roll fuser has a fuser belt having a portion that faces a surface of the first pressure member at the fusing nip. The pressure belt has a portion that faces another portion of the fuser belt at the fusing nip. The belt-roll fuser also has a group of elements configured to constrain the pressure belt such that another portion of the pressure belt faces a surface of a backing element at the fusing nip.

### FIELD OF DISCLOSURE

The disclosure relates to belt-roll fuser apparatuses, methods and systems involving a dual-belt fuser useful in printing. Specifically, the disclosure relates to a belt-roll fuser that maintains an effective nip pressure profile at a fusing nip.

### BACKGROUND

Conventional belt-roll fusers include an internal pressure roll (“IPR”), which entrains a fuser belt, and an external pressure roll (“EPR”). A fusing nip is conventionally defined by a region under pressure between the EPR and the IPR. Conventional belt-roll fusers often have a stripping shoe that is used to load an inner side of the fusing belt to generate an effective fusing nip pressure in a region beyond the region under pressure between the EPR and the IPR.

### SUMMARY

Conventional belt-roll fusers utilize a hard IPR and a soft EPR to form a fusing nip for fusing an image to a substrate that has just received toner from a transfer station. See FIG. 1 for an example of a related art belt-roll fuser architecture. Belt-roll fusers that utilize conventional IPR and EPR architecture often face frequent, and costly, maintenance requirements, as well image related defects such as, but not limited to, gloss related image quality (“IQ”) defects, stripping performance, and failure to demonstrate process latitude.

Apparatuses, methods and systems are disclosed in which various exemplary embodiments reduce the costs, frequency and difficulties associated with maintenance related tasks of conventional belt-roll fusers, and improve image quality performance.

According to one embodiment, a dual-belt fuser may be configured to include a first pressure member. The dual-belt fuser may also include a fuser belt having a portion that faces a surface of the first pressure member at a region defining a fusing nip. The dual-belt fuser may further include a pressure belt having a portion that faces another portion of the fuser belt at the fusing nip. The dual-belt fuser may additionally include a group of elements configured to constrain the pressure belt such that another portion of the pressure belt faces a surface of a backing element at the fusing nip.

According to another embodiment, a method for fusing an image to a substrate may include defining a fusing nip in an apparatus, wherein the apparatus may include a first pressure member, a fuser belt having a portion that faces a surface of the first pressure member at the fusing nip, a pressure belt having a portion that faces another portion of the fuser belt at the fusing nip, and a group of elements configured to constrain the pressure belt such that another portion of the pressure belt faces a surface of a backing element at the fusing nip. The method may also include causing, at least in part, the fuser belt, the pressure belt, and a substrate to move between the first pressure member and the backing element. The method may further include fusing an image to the substrate at the fusing nip.

According to another embodiment, a system configured to fuse an image to a substrate at a defined fusing nip may include a first pressure member. The system may also include a fuser belt having a portion that faces a surface of the first pressure member at the fusing nip. The system may further include a pressure belt having a portion that faces another portion of the fuser belt at the fusing nip. The system may additionally include a group of elements configured to constrain the pressure belt such that another portion of the pressure belt faces a surface of a backing element at the fusing nip. In the system, the fuser belt, the pressure belt and the substrate may be caused to move between the first pressure member and the backing element.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

FIG. 1 is a diagrammatical side view of a related art belt-roll fuser;

FIG. 2 is a diagrammatical side view of a fusing nip of a related art belt-roll fuser;

FIG. 3 is a diagrammatical side view of a dual-belt fuser, according to one example embodiment;

FIG. 4 is a flowchart of a process for fusing an image to a substrate, according to one example embodiment;

FIG. 5 is a diagram of a chip set that can be used to implement an example embodiment.

### DETAILED DESCRIPTION

Exemplary embodiments are intended to cover all alternatives, modifications and equivalents as may be included within the spirit and scope of the apparatuses, methods and systems as described herein.

Reference is made to the drawings to accommodate understanding of disclosed apparatuses, methods and systems. In the drawings, like reference numerals are used throughout to designate similar or identical elements. The drawings depict various embodiments related to embodiments of illustrative apparatuses, methods and systems.

Apparatuses and systems of embodiments may include systems for printing images on media by fusing marking material to a substrate using a dual-belt fuser.

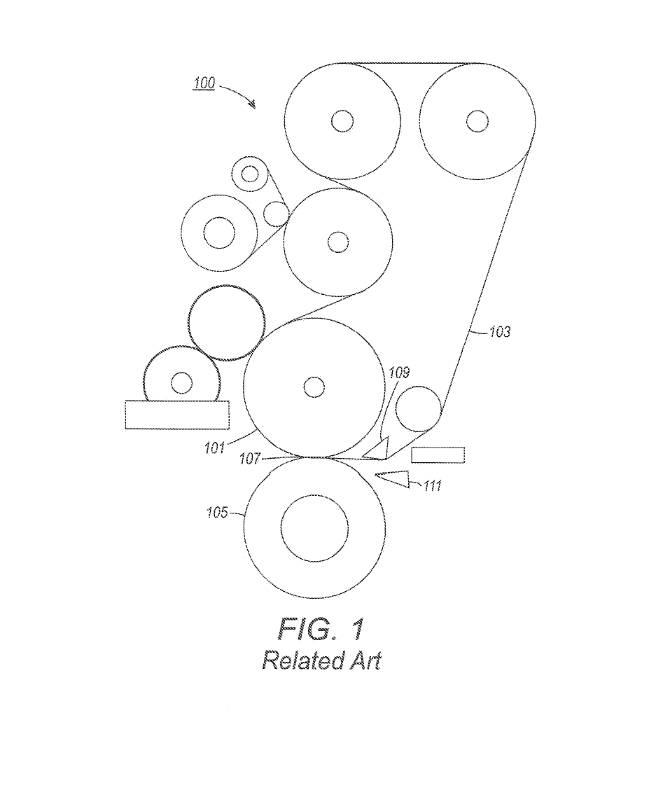

FIG. 1 illustrates a diagrammatical side view of an example related art belt-roll fuser 100. Conventional belt-roll fusers utilize a hard IPR 101, which entrain a fuser belt 103, and a soft EPR 105. The IPR 101, fuser belt 103 and EPR 105 form a fusing nip 107 for fusing an image to a substrate that has just received toner from a transfer station.

The substrate may be any form of media upon which marking material, such as toner, may be deposited. The substrate may be fed by the belt-roll fuser 100 through the fusing nip 107 in a process direction from a nip entrance to a nip exit. The belt-roll fuser 100 may then be configured to apply, e.g., pressure and heat at the fusing nip 107 to fuse a marking material to the substrate.

The fuser belt 103 may be entrained by one or more components of the belt-roll fuser 100. For example, the fuser belt 103 may have a first side and a second side. The first side, for example, may be an inner side that contacts the IPR 101, and may also contact other members of the belt-roll fuser 100 that may entrain the fuser belt 103. The second side may contact a substrate that passes through the fusing nip 107.

Belt-roll fusers that utilize conventional IPR and EPR architecture such as that illustrated in FIG. 1 often face frequent maintenance requirements, as well image related defects such as, but not limited to, gloss related IQ defects, stripping performance, and failure to demonstrate process latitude. These issues may be due to variability in fusing nip geometry caused by variables such as IPR and/or EPR elastomer bulge, temperature variation, shoe location, and inboard to outboard nip dynamics.

To help with the aforementioned image related defects, the related art belt-roll fuser 100 illustrated in FIG. 1 uses a strip shoe 109 to aid in stripping of a substrate from the fuser belt 103. The belt-roll fuser 100 also uses an air knife 111 to aid in stripping the substrate from the fuser belt 103. Paper tends to stick to the fuser belt 103 after passing through the fusing nip 107. The strip shoe 109 provides a small (<5 mm) stripping radius such that the paper will peel away from the fuser belt 103. However, because the fuser belt 103 wraps around the outside of the strip shoe 109, the related art belt-roll fuser 100 design results in a fusing nip 107 that has three different zones. These three different zones result in varying nip pressure throughout the fusing nip 107 and cause inconsistent stripping performance, which in turn causes the above-mentioned image-related defects

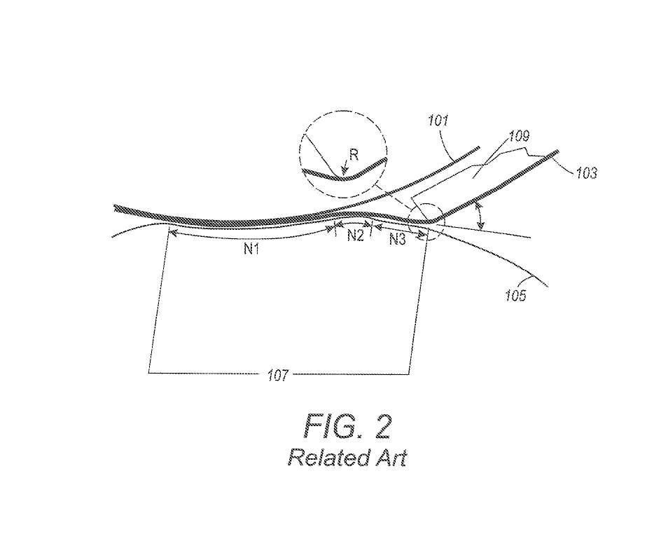

FIG. 2 illustrates a diagrammatical view of the geometry of the fusing nip 107, as discussed above. The fusing nip 107 is divided into three zones caused by the dual-roll architecture and the presence of the strip shoe 109. First, a primary, high-pressure, fusing nip (N1) is defined by a region generated by the interference of the IPR 101 and the EPR 105. Second, a low pressure contact nip (N2) is defined by a region in which the fuser belt 103 is in contact with the EPR 105 and not in contact with the IPR 101. Third, a free span (N3) is defined by a region between N2 and the strip shoe 109 where the fuser belt 103 is not in contact with either the IPR 101 or the EPR 105.

This three-nip geometry results in varying nip pressure throughout the fusing nip 107 and causes inconsistent stripping performance, which in turn causes the above-mentioned image-related defects. For example, the unsupported free span N3 may be one of the causes of image gloss defects. As the lead edge of a substrate travels through N2, substrates such as heavyweight sheets, for example, often do not conform to the shape of the EPR 105 with only belt tension producing a downward force (pressure in N2 may be less than 10 psi, for example). The downward force is only produced by belt tension in N2 in this example because the fuser belt 103 is no longer in contact with the IPR 101. Accordingly, because of the beam strength of the substrate, it may separate from the fuser belt 103, then retouch later as the beam length of the substrate increases. This separation and retouching causes a gloss defect called “icicles.”

Additionally, for example, depending on the density and location of an image, a substrate can stick to the fuser belt 103 or to the EPR 105 as it travels through the free span N3. The substrate may separate from and retouch the fuser belt 103 in the free span N3 causing image quality defects known as “retack.”

In addition to the image related defects discussed above, the presence of the strip shoe 109, as well as the EPR 105, increase maintenance costs and frequency. For example, the presence of the strip shoe 109 increases the amount of wear that the fuser belt 103 may experience. The strip shoe 109 may also wear over time and require replacement. This wearing may cause inconsistent image quality, as well as additional wear on the fuser belt 103. Further, EPR 105 may need to be replaced should it wear out or require repair.

Accordingly, there is a need for a fuser system that provides reliable stripping performance without the need of the strip shoe 109 while effectively driving the N2 & N3 regions to zero by controlling nip geometry.

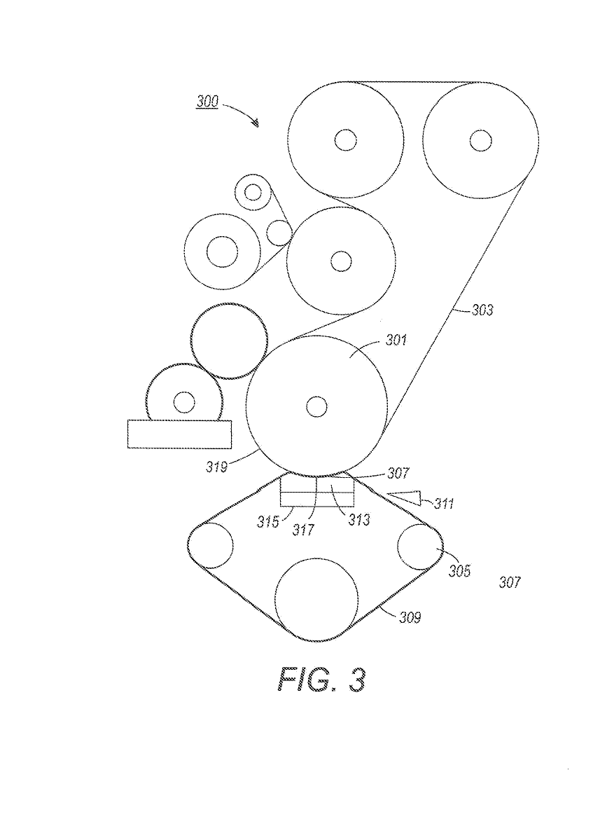

FIG. 3 illustrates a diagrammatical view of a dual-belt fuser 300 that controls nip geometry to affect image quality and stripping performance. The dual-belt fuser 300 includes a first pressure member such as IPR 301 that entrains a fuser belt 303. IPR 301, in this example, may be a drum or roll that is rotatable about its longitudinal axis. The dual-belt fuser 300 further includes a group of elements 305 that entrain an external pressure belt 309 in place of the EPR 105, discussed above in FIG. 1, of a conventional belt-roll fuser 100. External pressure belt 309 may comprise any elastomer material, rubber, polymer and/or metal. The external pressure belt 309 may also be coated with a friction reducing material such as, for example, silicone. The dual-belt fuser 300 may have an air knife 311 to aid in stripping a substrate from the fuser belt 303 after the substrate passes through a fusing nip 307.

Eliminating the strip shoe reduces image quality defects by driving compound nip geometries to zero. Additionally, belt life in a belt roll fuser may be increased because a conventional strip shoe may cause excessive wear on the fuser belt. As such, removing a strip shoe from a conventional belt roll fuser may lower the repair costs of such a system because the fuser belt would not have to be replaced as often. Further, a dual belt fuser, as discussed herein, has the added benefit of reducing repair costs because replacing a belt that is in place of a conventional external pressure member that is a roller is a much less expensive exercise. Also, IQ defects may occur as a result of thermal issues and/or warm up transients that a conventional external pressure roller may experience. A belt that replaces such a roller may experience less thermal issue and/or warm up transients such as variability caused by expansion and contraction caused by temperature variations, for example.

The group of elements 305, in conjunction with the external pressure belt 309, defines the fusing nip 307 in a region at which the IPR 301 and the external pressure belt 309 are in contact with one another. The group of elements 305 may comprise drums, rolls, shims, shoes, or any other element that may be used to direct, support or constrain the external pressure belt 309. For example, the group of elements 305 may include a backing element 313 that is proximate the IPR 301 at the fusing nip 307. The backing element 313 may be configured to apply pressure uniformly throughout the fusing nip 307 in a direction toward the IPR 301.

According to one example embodiment, the backing element 313 may be movable to control nip geometry and to accommodate the fuser belt 303 and the external pressure belt 309, as well as any substrate that is caused to pass through the fusing nip 307. Accordingly, to accommodate the fuser belt 303, the pressure belt 309 and the substrate, while applying a predetermined pressure in the fusing nip 307, a backing element pressure member 315 may cause the backing element 313 to apply pressure in the fusing nip 307 toward the IPR 301.

The backing element pressure member 315 may be any of, for example, a spring actuated system that causes the backing element 313 to apply pressure at the fusing nip 307, a pneumatic device that causes the backing element 313 to apply pressure at the fusing nip 307, or any other fuser that enables the backing element 313 to apply the predetermined pressure at the fusing nip 307, regardless of what type of substrate is passing through the fusing nip 307.

Additionally, the variance in position of the backing element 313 may also allow for different belt sizes for the fuser belt 303 and the external pressure belt 309 to be accommodated. For example, thicker or thinner belts may be used in the dual-belt fuser 300 for different print job requirements, varying performance requirements such as printer speed, or to accommodate heavier or lighter substrates, as well as to account for thermal expansion of the components of the dual-belt fuser 300 such as the IPR 301 and/or the backing element 313, for example. Reducing the thickness of the belts, as well as any coating thereon, may have an effect on the performance of the dual-belt fuser 300 such as improving image quality and consistency. A thinner coating, for example, would effectively reduce an amount of possible deformation that could occur to any of the belts as a result of pressure in the fusing nip 307, or any thermal expansion that any of the belts could experience in the fusing nip 307.

Alternatively, or in addition to the backing element 313 being movable, the IPR 301 may be adjustable, along with other components of the dual-belt fuser 300 to accommodate the fuser belt 303, external pressure belt 309 and a substrate in the same manner as discussed above to apply the predetermined pressure at the fusing nip 307.

According to various embodiments, the IPR 301 may be made from a metal, or from any elastomer or rubber core that may be deformable. The backing element 313 may also be made from a metal or from an elastomer or rubber that is deformable. Depending on the particular print job requirements, or any variables that may need to be adjusted to produce print jobs at a desired quality level, the backing element 313 may not deform under the predetermined pressure in the fusing nip 307, or at least deform less than the IPR 301 under the same pressure.

According to various embodiments, the backing element 313 and the IPR 301 may be in a fixed position such that the fuser belt 303 and the external pressure belt 309 may be squeezed between the IPR 301 and the backing element 313 at the fusing nip 307. The predetermined pressure that occurs at the fusing nip 307, in this embodiment, is caused by the presence of the fuser belt 303 and external pressure belt 309 in a space between the IPR 301 and the backing element 313 that is just large enough to fit the fuser belt 303 and external pressure belt 309. To accommodate a substrate between the fuser belt 303 and the external pressure belt 309, the fuser belt 303 and/or the external pressure belt 309 may deform, thereby applying pressure on the substrate.

According to various embodiments, the backing element 313 may have a surface shape that is configured to mate with a surface of the IPR 301. For example, the backing element 313 may have a concave surface 317 in at least the fusing nip 307 region to accommodate an external surface 319 of the IPR 301. Because the IPR 301 is a roll, the external surface 319 of the IPR 301 is convex. The radius of the convex external surface 319 of the IPR 301 may be of a size that is configured to mate with the concave surface 317 of the backing element 313. Because these surfaces are configured to mate, the internal radius of the concave surface 317 of the backing element 313 may accordingly be larger than an external radius of the convex surface 319 of the IPR 301.

Alternatively, the radii of the concave surface 317 and the convex surface 319 may be equal, or the convex surface 319 may be greater than the concave surface 317 at any point, or across the entire fusing nip 307 to accommodate different fusing nip 307 geometries that result in, for example, customizable predetermined pressures in the fusing nip 307. This may be helpful where different strip radii may be desired at an outboard and/or inboard edge of a substrate versus a center region of a substrate, for example.

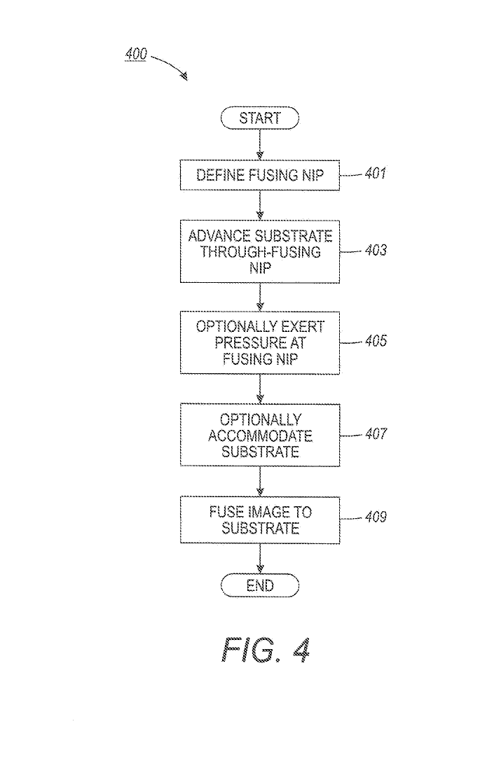

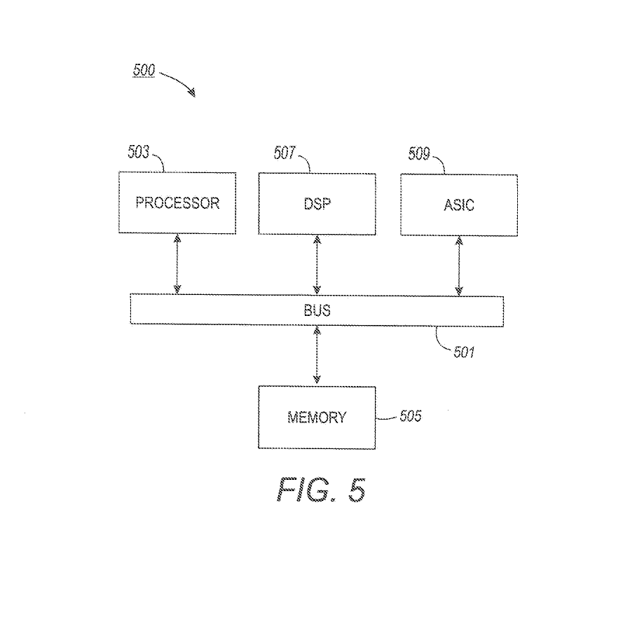

FIG. 4 is a flowchart of a process for fusing an image to a substrate, according to one embodiment. In one embodiment, the dual-belt fuser 300 performs the process 400 by way of a control module implemented in, for instance, a chip set including a processor and a memory as shown in FIG. 5. In step 401, the dual-belt fuser 300 defines a fusing nip 307 in the dual-belt fuser 300. The dual-belt fuser 300 may have, for example, a first pressure member such as the IPR 301 and a fuser belt 303 that is entrained by the IPR 301. In the dual-belt fuser 300, a portion of the fuser belt 303 faces a surface of the IPR 301 at the fusing nip 307. The dual-belt fuser 300 may also have a an external pressure member that may be the external pressure belt 309, for example, that has a portion that faces a portion of the fuser belt 303 that is other than the portion of the fuser belt 303 that faces the surface of the IPR 301 at the fusing nip 307.

In a case where the external pressure member is an external pressure belt 309, the dual-belt fuser 300 may also have a group of elements 305 configured to constrain the pressure belt 309 such that another portion of the pressure belt 309 faces a surface of a backing element 313 at the fusing nip 307. The external pressure belt 309 may be entrained by the group of elements 305 so as to be movable between the backing element 313 and the IPR 301.

Accordingly, the process continues to step 403 in which the dual-belt fuser 300 causes, at least in part, the fuser belt 303 and the pressure belt 309 to move between the IPR 301 and the backing element 313. By moving the fuser belt 303 and the pressure belt 309, the substrate is caused to advance through the fusing nip 307 in a process direction from a nip entrance to a nip exit.

Next, in step 405, the dual-belt fuser 300 optionally causes, at least in part, the backing element 313 to exert a predetermined pressure on the pressure belt 309 in a direction toward the IPR 301 at the fusing nip 307 by way of a backing element pressure member 315. The predetermined pressure may be an amount such that at least the fuser belt 303 and the pressure belt 309 are moveable between the IPR 301 and the backing element 313. The position of the backing element 313 may be adjusted, as discussed above, by way of the backing element pressure member 315 so that the substrate may be accommodated between the fuser belt 303 and the pressure belt 309 while maintaining the predetermined pressure in the fusing nip 307. Accordingly, in step 407, the dual-belt fuser 300 optionally causes, at least in part, the backing element pressure member 315 to enable the substrate to be accommodated between the fuser belt 303 and the pressure belt 309 while maintaining the predetermined pressure in the fusing nip 307. Then, in step 409, the dual-belt fuser 300 fuses an image to the substrate at the fusing nip 307.

FIG. 5 illustrates a chip set or chip 500 upon which an embodiment discussed above may be implemented. Chip set 500 is programmed to control nip geometry as described herein and includes, for instance, a processor and memory components incorporated as one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 500 can be implemented in a single chip. It is further contemplated that in certain embodiments the chip set or chip 500 can be implemented as a single “system on a chip.” It is further contemplated that in certain embodiments a separate ASIC would not be used, for example, and that all relevant functions as disclosed herein would be performed by a processor or processors. Chip set or chip 500, or a portion thereof, constitutes an example means for performing one or more steps of controlling nip geometry.

In one embodiment, the chip set or chip 500 includes a communication mechanism such as a bus 501 for passing information among the components of the chip set 500. A processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to perform specialized functions not easily performed by a more general purpose processor. Other specialized components to aid in performing the functions described herein may include one or more field programmable gate arrays (FPGA), one or more controllers, or one or more other special-purpose computer chips.

In one embodiment, the chip set or chip 500 includes merely one or more processors and some software and/or firmware supporting and/or relating to and/or for the one or more processors.

The processor 503 and accompanying components have connectivity to the memory 505 via the bus 501. The memory 505 includes both dynamic memory (e.g., RAM, magnetic disk, writable optical disk, etc.) and static memory (e.g., ROM, CD-ROM, etc.) for storing executable instructions that when executed perform the steps described herein to control nip geometry. The memory 505 also stores any data associated with or generated by the execution of the steps discussed herein.

While the above apparatuses, methods and systems for controlling nip geometry are described in relationship to exemplary embodiments, many alternatives, modifications, and variations would be apparent to those skilled in the art. Accordingly, embodiments of apparatuses, methods and systems as set forth herein are intended to be illustrative, not limiting. There are changes that may be made without departing from the spirit and scope of the exemplary embodiments.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. An apparatus useful in printing comprising:
a first pressure member;
a fuser belt having a portion that faces a surface of the first pressure member at a region defining a fusing nip;
a pressure belt having a portion that faces another portion of the fuser belt at the fusing nip; and
a group of elements configured to constrain the pressure belt such that another portion of the pressure belt faces a surface of a backing element at the fusing nip.

2. The apparatus of claim 1, further comprising:
a backing element pressure member that is configured to cause, at least in part, the backing element to exert a predetermined pressure on the pressure belt in a direction toward the first pressure member at the fusing nip, the pressure being an amount such that at least the fuser belt and the pressure belt are moveable between the first pressure member and the backing element.

3. The apparatus of claim 1, wherein the backing element pressure member is configurable to enable a substrate to be accommodated between the fuser belt and the pressure belt while maintaining the predetermined pressure.

4. The apparatus of claim 3, wherein the backing element pressure member is spring actuated.

5. The apparatus of claim 3, wherein the backing element pressure member is pneumatic.

6. The apparatus of claim 3, wherein the predetermined pressure is within a range.

7. The apparatus of claim 1, wherein
the surface of the first pressure member at the fusing nip is convex,
the surface of the backing element at the fusing nip is concave, and
the surface of the first pressure member is configured to mate with the surface of the backing element at the fusing nip to a degree that enables at least the fuser belt and the pressure belt to be moveable between the first pressure member and the backing element while accommodating a substrate between the fuser belt and the pressure belt.

8. The apparatus of claim 7, wherein
the convex surface is formed by an outer arc having an outer radius,
the concave surface is formed by an inner arc having an inner radius, and
the inner radius is greater than the outer radius such that a predetermined pressure is maintained throughout the fusing nip.

9. The apparatus of claim 1, wherein the backing element is configured to deform less than an amount that the first pressure member deforms under a predetermined pressure.

10. A method for fusing an image to a substrate comprising:
defining a fusing nip in an apparatus, the apparatus comprising:
a first pressure member;
a fuser belt having a portion that faces a surface of the first pressure member at the fusing nip;
a pressure belt having a portion that faces another portion of the fuser belt at the fusing nip; and
a group of elements configured to constrain the pressure belt such that another portion of the pressure belt faces a surface of a backing element at the fusing nip;
causing, at least in part, the fuser belt, the pressure belt, and a substrate to move between the first pressure member and the backing element; and
fusing an image to the substrate at the fusing nip.

11. The method of claim 10, further comprising:
causing, at least in part, the backing element to exert a predetermined pressure on the pressure belt in a direction toward the first pressure member at the fusing nip by way of a backing element pressure member, the pressure being an amount such that at least the fuser belt and the pressure belt are moveable between the first pressure member and the backing element.

12. The method of claim 11, further comprising:
causing, at least in part, the backing element pressure member to enable the substrate to be accommodated between the fuser belt and the pressure belt while maintaining the predetermined pressure.

13. The method of claim 12, wherein the backing element pressure member is spring actuated.

14. The method of claim 12, wherein the backing element pressure member is pneumatic.

15. The method of claim 12, wherein the predetermined pressure is within a range.

16. The method of claim 10, wherein
the surface of the first pressure member at the fusing nip is convex,
the surface of the backing element at the fusing nip is concave, and the surface of the first pressure member is configured to mate with the surface of the backing element at the fusing nip to a degree that enables at least the fuser belt and the pressure belt to be moveable between the first pressure member and the backing element while accommodating the substrate between the fuser belt and the pressure belt.

17. The method of claim 16, wherein
the convex surface is formed by an outer arc having an outer radius, the concave surface is formed by an inner arc having an inner radius, and the inner radius is greater than the outer radius such that a predetermined pressure is maintained throughout the fusing nip.

18. The method of claim 10, wherein the backing element is configured to deform less than an amount that the first pressure member deforms under a predetermined pressure.

19. A system configured to fuse an image to a substrate at a defined fusing nip, comprising:
a first pressure member;
a fuser belt having a portion that faces a surface of the first pressure member at the fusing nip;
a pressure belt having a portion that faces another portion of the fuser belt at the fusing nip; and
a group of elements configured to constrain the pressure belt such that another portion of the pressure belt faces a surface of a backing element at the fusing nip,
wherein the fuser belt, the pressure belt, and the substrate are caused to move between the first pressure member and the backing element.

20. The system of claim 19, wherein the backing element is configured to deform less than an amount that the first pressure member deforms under a predetermined pressure.
